(19) United States
(12) Patent Application Publication
(10) Pub. No.: US 2009/0029337 A1
(43) Pub. Date: Jan. 29, 2009

(54) Compact personal presentation coach

(76) Inventors: Jill M. Nasci, Sammamish, WA (US); Nicole M. Jepsen, Seattle, WA (US)

Correspondence Address: Patrick M. Dwyer PC, #322, 14419 Greenwood Avenue N, Seattle, WA, 98133, US

(21) Appl. No.: 11/881,692

(22) Filed: Jul. 26, 2007

(51) Int. Cl. G09B 19/00

(52) U.S. Cl. 434/365

(57) ABSTRACT

Method and apparatus are disclosed for a coach to be used in creating an optimal personal presentation. A unique, iconic symbol is displayed on the outside of a compact information display structure to specify a particular type of individual with distinguishing characteristics who is to use the personal presentation coach. The coach targets a specific component of personal presentation, such as clothing, make-up or business etiquette, and optionally, specific situations in which the coach will be used. The coach displays information in small conveniently accessible blocks or frames, each block easily assimilated by a user. Several embodiments for the physical structure of the coach are disclosed, including flat or multi-folded sheets, a fan, a flip book, a slider, a multi-layered wheel and digitally-created displays in a compact digital display device.

### TECHNICAL FIELD

The invention relates to method and apparatus for creating personal presentation through the use of a compact information display device; more particularly, it relates to method and apparatus for creating a personal presentation through the use of a compact information display device by a selected individual where personal presentation information is most useful.

### BACKGROUND OF THE INVENTION

Many people are interested in how to dress, accessorize, apply make-up, groom themselves and cut or style their hair in order to make an optimal personal presentation in particular situations. In addition, it is generally believed that people's homes, cars and even pets contribute to their personal presentation. Information relating to personal presentation is more than ever present in the current global economy and awareness. Information relating to personal presentation while traveling in foreign cultures can include physical posture, eye contact, phrases which are appropriate and many other business practices and conventions of etiquette. Where do individuals seek information to help them create an optimal personal presentation for themselves? Information about fashion, shopping, etiquette, travel, money management and other topics is abundantly available in the form of books, magazines, television shows and the Internet; in fact, the amount of such information available on these subjects is copious and even overwhelming.

Personal presentation information is advantageously related to specific characteristics of the individual, such as their body type, race, age, whether they are male or female, even their religion or political affiliations. In addition, individuals have personality types and personal preferences which influence their chosen presentation. For example, an upcoming female artist may be well padded in the hips, of middle age, liberal and of a romantic, free flowing disposition. The optimal personal presentation she creates would be very different from that chosen by a tall, thin, young business woman with conservative political views and a no-nonsense outlook on life. Individuals are constantly searching for information about the best choices to make to optimize their presentation. Information is available, but not easily selected. An individual must cull information from numerous books and magazine articles, watch many different television shows or research extensively on the Internet. This involves reviewing vast amounts of information that is not applicable to the individual in order to somehow obtain the small amount that is useful. Alternatively, an individual may consult a presentation specialist in order to obtain information specific to their needs and preferences. This is the method chosen by the wealthy and famous, but it is generally too costly for the majority of the population.

In addition, presentation depends on the situation, culture, time of year, even the weather. A sharp business look is not necessarily the same in New York City, Paris and Cairo. Low necklines on a woman or rolled up sleeves on a man do not create the same impression in Boston as they do in Rio de Janeiro. Again, finding the information appropriate to a given situation is arduous and time consuming.

Even if the information is available, taking a fashion or etiquette book or a stack of magazines to the shopping mall is inconvenient. The information about which blouse to select for an individual's body type is needed when standing in front of the blouse rack, not at home. An individual does not generally take their television programming with them on a trip to Tokyo and certainly not into the boardroom to be viewed just before meeting the investment bankers. Something is needed that will concisely and compactly communicate information needed to make wise choices or conduct oneself with the appropriate etiquette at the site of usage. It must be portable and clearly communicate which individuals should be using it, so that relevant recommendations are readily accessible. It also should provide information in small conveniently accessible blocks, divided up in such a way that each displayed section has a specific situational usage.

### DISCLOSURE OF THE INVENTION

The personal presentation coaches disclosed herein each communicate information to be used for the creation of an optimal personal presentation that is specific to a particular type of individual, and, preferably, do not contain useless and extraneous information for anyone who has the distinguishing characteristics of that individual type. Furthermore, each coach addresses a specific component of personal presentation, for example, “clothing”, “make-up”, “home decor” or “business etiquette”. Optionally, the coaches address the specific situations that they will be used for, for example, “Business Attire in Cairo” or “Business Practices in Japan”. In addition, the coaches display information in small conveniently accessible blocks or frames, each of which is easily assimilated.

Each coach is intended to be used by a specific type of individual, chosen from a larger set of defined individual types. Part of the optimal personal presentation system disclosed herein is a determination and definition of the prevailing characteristics of various individual types within the larger set. After defining this set of individual types for the purpose of addressing a presentation component, coaches are developed for each type defined. For example, suppose the personal presentation component being addressed is clothing, and the component is further refined to be clothing for a woman. The set of coaches developed addresses which clothing is most suitable for individual female body types. It is determined that some women have all of the following characteristics: narrow waist, slender neck, smaller bust and rib cage, narrow shoulders and wide hips and bottom. Another type identified has the following characteristics: waist wider than bust and hips, wide neck, sloping shoulders. Still another type identified has the following characteristics: long neck, smaller bust, waist high on the torso, small bottom and long legs. Once these types of individuals have been defined and a list of their characteristics made, optimum personal presentation recommendations and educational material can be developed and consolidated for each individual type and a coach produced for each individual type within the larger set.

Advantageously, numerous sets of individual types can be defined for the purposes of personal presentation. Within these sets, numerous individual types can be identified, providing organization for the vast amount of personal presentation information currently available and promoting the development of new personal presentation recommendations and educational material in order to amplify this organizational system. For example, people doing business around the world are organized into sets of individual types according to which business they are in, their country of origin, their race, their temperament and other factors. A wild Italian painter would probably be seeking personal presentation recommendations different from a conservative international financier from Tokyo.

Personal presentation has many aspects, herein referred to as presentation components. Part of the optimal personal presentation system disclosed herein is to choose a presentation component or, optionally, a combination of components for each coach. Components which involve the physical body are clothing, makeup, hair styling, accessories, jewelry, nail grooming, and scents. Other aspects of the physical body which might be changed are eye, teeth and skin color, orthodontia, tattoos and plastic surgery. Other personal presentation components involve a person's surroundings, such as their car, home and office decoration, furniture, pets, communication devices (such as cell phones) and computing devices (such as laptops), the food they prepare, the food they consume, restaurants, hotels, spas and other businesses they patronize and the neighborhoods where they live and work. Another set of important personal presentation components has to do with personal behavior: etiquette, language used, posture, eye contact and tone of voice. As part of etiquette and personal behavior, expressions of relationships with family and friends, expressions of attitudes and expressions of various emotions can be addressed. The above list of personal presentation components is intended to be illustrative and not exhaustive; any aspect of personal presentation may be used in putting the optimal presentation into effect.

Optionally, the creation of optimal personal presentation may be further refined to a selected situation for the presentation. For example, clothing may be recommended for Winter, Spring, Summer or Fall. Any presentation component can be refined to target a certain country or culture. For example, a woman shopping for clothing, may want recommendations for business attire specific to coastal Brazil in Summer. Certainly, recommendations for such clothing would be different from recommendations for clothing for coastal England in Winter. Such refinements are also optionally part of the disclosed optimal personal presentation system.

Both methods and apparatus are disclosed for the purpose of consolidating, organizing and transporting information used in creating an optimal personal presentation to the site of that information usage. The apparatus is a compact, portable structure, the structure displaying information. The information is displayed electronically or in a printed format. The displayed information may be graphics, text or a combination of the two. Advantageously, the apparatus prominently displays a unique iconic symbol at the time of purchase to identify a specific type of individual that should use the coach and contains recommendations or educational information to be used in creating a selected personal presentation. The recommendations and information are displayed in small conveniently accessible blocks, with some blocks preferably suitable for usage in a specified situation.

The unique iconic symbol allows a purchaser of the coach to quickly identify which version of the coach is for them, for example, while standing in front of a rack of coaches in the form of printed guides or while viewing a webpage that offers coaches in the form of printed guides with thumbnail images of each guide. Advantageously, the unique iconic symbol is any combination of images that quickly communicates the type of individual to use the coach and, optionally, the presentation question for which the coach is intended. One coach covers the presentation component of selecting clothing that would be most flattering for a specific body type. Suppose the coach is for a woman who has a small bust and wide hips. A unique symbol that is used is a schematic outline of the female form with a triangle superimposed upon it, the base of the triangle at the hips. If a woman has a small bust, wide waist and narrow hips, she chooses the coach with the unique symbol of an oval over a schematic outline of the female form. For the woman with a long neck, smaller bust, a waist high on the torso, a small bottom and long legs, the coach with a unique symbol of a rectangle is easily recognizable. Another example is a coach for etiquette practices in a foreign country, the question being what are the top 10 business practices for African American businessmen doing business in Japan. One graphic that might be used is a black outline of a man in a business suit in front of a Japanese flag.

Optionally, the unique iconic symbol is followed by a textual description of what the graphic means. In the case of the woman purchasing clothing above, for example, a title of “Triangle” is included next to the graphic, with a bulleted list of text such as, “Narrow waist”, “Slender neck”, “Smaller bust and rib cage”, and “Wider hips and bottom”.

The personal presentation coach then displays recommendations and educational information specific to that individual. Information is advantageously arranged in small conveniently accessible blocks. The blocks are displayed through display apparatus, now known or later developed. Advantageous apparatus for display are a single flat sheet divided into frames, a tri-folded or multi-folded sheet, a fan, a flip book, a spiral book, a booklet, a slider, a multi-layered wheel and various digitally-created displays in a compact digital display device, such as a cell phone or palm held computer. The method of display advantageously allows the user to access the information in the physical location or situation it is most needed. For example, in the case of a woman shopping for clothes, a block of information regarding which blouses are most flattering for her body type is displayed in a format quickly scanned in front of a blouse rack in the department store. For another example, a person doing business in a foreign country, a block of information regarding “Introductions” or “Initial meeting” is displayed in a format that can be quickly scanned just before the initial meeting. Another block is titled “Phone conversations” for scanning just before making phone contact.

One of the information divisions or blocks advantageously contains textual description of the goals and strategies for this type of purchase or information for the best practices for this specific type of individual. For example, for the triangularly shaped woman using the personal presentation coach as a shopping aid, the section is titled, “Goals and Strategies” and contains a bulleted list with recommendations such as “Focus attention on upper body with detailed tops in bright colors,” and “Downplay lower body with muted colors and little or no detail on pants and skirts”. Alternately, a list in outline form is used. For example, one outline line reads, “Focus attention on upper body”. This is followed by several subordinate lines reading, “Chunky necklaces”, “Scarves”, “Hats” and “Detailed tops in bright colors”.

Recommendations are further made using one or more blocks or sections with graphic or textual descriptions covering the features of the best things to purchase or with the educational material needed in a given situation. For example, in the case of women's clothing, sections are included for “Best tops”, “Best Pants”, “Best Jackets” and so forth, with bulleted lists of what to look for, such as, “Use shoulder pads”, or “Trouser and skirts should be soft and flowing, never tight”.

Another advantageous inclusion is a block or section for graphic or textual descriptions of “Do's and Don'ts”. This is a method, commonly used in the art, of quickly communicating recommendations. “Do's” are a compact listing of actions to take or keep in mind about what is best to do for the personal presentation component and selected situation being addressed. “Don'ts” similarly, are a compact listing of actions not to take, recommendations for aspects to avoid in purchasable items, and other information to keep in mind generally about what is best not to do for the personal presentation component and selected situation being addressed. Like the “Goals and Strategies”, “Do's and Don'ts” are generally more global in application than other recommendation sections like “Best blouses”; recommendations in the “Do's and Don'ts” block may span several of the other recommendation sections. For example, the woman above is instructed in a section titled “Do”, “Buy separates”, “Find a great tailor” and “Keep skirts, hosiery and shoes in the same tone”. A section titled “Don't” recommends she not wear “Tight pants and skirts”, “Any trim on lower half of your body”, and “Jackets and tops that end at the widest part of your body”. “Do and Don'ts” may also be communicated graphically, for example, by using the international symbol for “Do not” (a red circle with a slash) or a red stoplight followed by graphics or images of the individual clothing items.

Also included is a panel or section for graphic or textual descriptions for “Cheats”, which are work-arounds for the “Do's and Don'ts”. Sometimes a “Do” or a “Don't” is impossible to avoid, and the “Cheats” block provides a compact listing of recommendations of what to do in those situations. In most cases, “Cheats” will be addressed to items in the “Do's and Don'ts” block, but they could also be addressed to any other recommendations that were made elsewhere in the personal presentation coach. In the above case of a woman buying clothing, one of the “Don'ts” is “Tight pants and skirts”. “Cheats” for this “Don't” include, “Shapewear” and “Pinstripes”.

The display of recommended actions and educational material is advantageously arranged in the most easily assimilated form. At the same time, the coach should be portable to the physical site where it is most useful. “Goals and Strategies” and the combined “Do's”, “Don'ts” and “Cheats” sections are advantageously in a format that is quickly scanned just prior to shopping or interacting in a social situation. The more specific recommendations, such as “Best Blouses” in the clothing example, are advantageously displayed in a single block that is readily accessible while the shopper is at the shopping site.

To further the goals of portability and assimilation, various physical embodiments of the personal presentation coaches are contemplated. For example, a laminated tri-folded brochure displays the “Do's”, “Don'ts” and “Cheats” sections on the back when folded in a closed position. Each panel contains a section of related recommendations, such as “Best Blouses”, where the brochure can be folded open to reveal just that section, as one would fold and use a map. Another embodiment is a multi-layered wheel. The top layer contains the unique iconic symbol and general information such as the “Goals and Strategies”. On the back, the “Do's”, “Don'ts” and “Cheats” sections are displayed. There is a window in the top layer of the wheel through which selected recommendations are displayed and the user rotates the inner wheel of printed material to display only the section of interest for their specific situation, such as the “Best Pants” section when they are standing in front of a rack of pants at the mall. In addition, the personal presentation coach is particularly suitable for display in a hand held electronic device. Digital “pages” imported into the device as linked web pages or a complete software application display the information blocks as individual pages on the device's display screen and navigation from page to page is accomplished through programmed navigation techniques that are now known or later developed.

To summarize, a personal presentation coach adapted for creating a personal presentation for a selected type of individual is disclosed. The apparatus is a compact information display structure of printed or digitally displayed graphics and textual material. Displayed upon the apparatus is an iconic symbol uniquely associated with a single selected type of individual, and, within the structure of the apparatus, are one or more blocks of information or frames with information adapted for creating personal presentation only for the selected type of individual. The information consists, generally, of recommended actions adapted for creating the personal presentation (for example, purchasing items with recommended features) and/or educational material specific to a personal presentation component.

The compact information display structure can display information in various display forms, such as graphics, text, photographs, symbols and icons.

Contemplated display structures for the apparatus include a single flat sheet, a tri-folded or multi-folded sheet, a fan, a flip book, a slider, a multi-layered wheel and digitally-created displays in a compact digital display device.

Next to the symbol uniquely associated with a single type of individual, is optionally displayed a frame containing a textual description identifying the selected type of individual.

Also optional parts of the apparatus are a block containing goals and strategies for creating personal presentation only for the selected type of individual, a block containing actions to do and actions not to do for the selected type of individual, and a block containing actions that would cheat the actions to do and actions not to do (or would cheat other recommendations) for the selected type of individual.

Also disclosed is a method for coaching a selected type of individual in creating an optimal personal presentation, the method performed by the following optional steps in any order: identifying distinguishing characteristics of the selected type of individual, selecting a characteristic of the type of individual and associating it to a unique iconic symbol, associating the iconic symbol to recommended actions adapted for creating the personal presentation, and/or educational material specific to a personal presentation component, and displaying the iconic symbol and the iconic symbol's associated information on a compact information display structure adapted to be carried by the selected type of individual.

The compact information display structure selected is optionally any of the following: a single flat sheet, a tri-folded or multi-folded sheet, a fan, a flip book, a slider, a multi-layered wheel and digitally-created displays in a compact digital display device.

It is also an optional step to create a textual description of the meaning of the unique symbol or a textual description of the individual type and to display the textual descriptions on the compact information display structure.

It is also an optional step to relate the unique symbol to goals and strategies for creating personal presentation only for the type of individual and display the goals and strategies on the compact information display structure to the individual.

It is also an optional step to relate the unique symbol to actions to do and actions not to do for the type of individual and to display these “Do's” and “Don'ts” on the compact information display structure to the individual.

It is also an optional step to relate the unique symbol to actions that would cheat the actions to do and actions not to do, or any of the recommendations and educational information that is contained in the displayed information, and display these “Cheats” on the compact information display structure to the individual.

Method and apparatus are disclosed for a coach to be used in creating an optimal personal presentation. A unique, iconic symbol is displayed on the outside of a compact information display structure to specify a particular type of individual with distinguishing characteristics who is to use the personal presentation coach. The coach targets a specific component of personal presentation, such as clothing, make-up or business etiquette, and optionally, specific situations in which the coach will be used. The coach displays information in small conveniently accessible blocks or frames, each block easily assimilated by a user. Several embodiments for the physical structure of the coach are disclosed, including flat or multi-folded sheets, a fan, a flip book, a slider, a multi-layered wheel and digitally-created displays in a compact digital display device.

### BRIEF DESCRIPTION OF THE DRAWINGS

FIG. 1 is a front perspective view of a tri-folded flat sheet embodiment of the personal presentation coach in a semi-closed configuration.

FIG. 2 is an orthogonal front view of a tri-folded flat sheet embodiment of the personal presentation coach in an open configuration.

FIG. 3 is an orthogonal back view of a tri-folded flat sheet embodiment of the personal presentation coach in an open configuration.

FIG. 4 is a front perspective view of a flip book embodiment of the personal presentation coach.

FIG. 5 is a front perspective view of a fan embodiment of the personal presentation coach.

FIG. 6A is a front perspective view of a slider embodiment of the personal presentation coach.

FIG. 6B is a cutaway side view of a slider embodiment of the personal presentation coach. FIG. 7A is an orthogonal front view of a wheel embodiment of the personal presentation coach.

FIG. 7B is an exploded front perspective view of a wheel embodiment of the personal presentation coach.

FIGS. 8A & 8B are front orthogonal views of a hand held digital device embodiment of the personal presentation coach.

FIGS. 9A & 9B are a flowcharts of steps for a method of creating an optimal personal presentation.

### BEST MODE OF CARRYING OUT THE INVENTION

The term “optimal”, as regards personal presentation, is defined according to common usage and not necessarily as used in an engineering sense where there is only one discreet point of optimization for a given set of factors. The purpose of the personal presentation creation system disclosed is to help individuals optimize their personal presentation (or at least one component of it) within the given factors at their disposal in a selected situation. Of course, some of those factors are discretionary, such as temperament or preferred colors, while others are physical, such as body dimensions. The goal is for an individual, and those with whom the individual is interacting, to believe the individual is making a personal presentation most likely to contribute to the achievement of the individual's life goals, given the individual's personal preferences and physical attributes.

“Selected situations” as used herein is defined as a further refinement of a coach to a specific geography, time or interpersonal situation. In one of the examples above, the presentation component is clothing and the individual type is a female “triangle”. Examples of selected situations which are used to further refine the coach are a specific country such as Brazil, a specific time such as Fall, a specific interpersonal situation, such as business interactions.

Unique iconic symbols are used as described above to quickly communicate the type of individual the coach is intended for and, optionally, the presentation question the coach addresses. The iconic symbols are “unique” within the personal presentation creation system. No two personal presentation coaches within the system will have the same symbol. The symbol may be composed of geometric shapes, schematic outlines, icons, symbolic language, blocks of color or any other visual iconic components that communicate individual characteristics, presentation components and situational settings, but are generally not photographs, nor drawings and paintings that are intended to create a realistic portrayal. Components of the symbols may be shared. For example, the rectangle may appear over the schematic outline of a woman on one coach and over the schematic outline of a man on another. Optionally, color is used to distinguish between symbols on two different coaches, for example, a black schematic outline for an African American and a white schematic outline for a Caucasian. However, the iconic symbol is unique in its combination of components for each coach.

The information used to create a personal presentation is integrated into a compact, portable structure. Several such structures are described below and each structure meets certain criteria. By “compact and portable”, it is intended that the structure is light enough and of a size such as to be easily carried on an individual's person, in pocket, purse, briefcase or other carrying case. It also can be held in one hand while viewing the individual display areas or blocks of information.

Information may be displayed and thereby communicated in many different forms, such as text, graphics (which includes drawings, illustrations, maps, flowcharts, graphs, organizational charts, block diagrams), symbols, icons and photographs, in addition to other forms of display now known and later developed.

Discreet packages of information useful to create a personal presentation are referred to herein as “blocks”. Blocks of information may be framed in any manner that indicates the information is grouped into a discreet package. Methods well known in the art are drawing a border around the information, placing the information in a colored section, displaying the information in an outline format or simply creating a margin of blank space around the information. In several of the embodiments disclosed below, a window is used to reveal only one block of selected information. This block is replaced with other selected blocks by manipulation of the apparatus, and individual blocks are generally not displayed at the same time.

Turning now to the drawings, the personal presentation coach will be described in preferred embodiments by reference to the numerals of the drawing figures wherein like numbers indicate like parts.

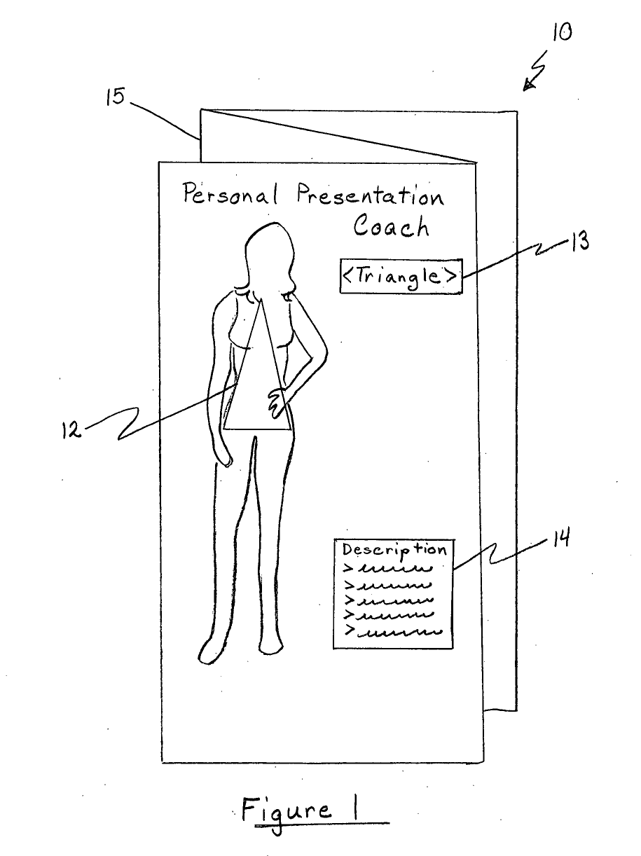

FIG. 1 is a front perspective view of a tri-folded flat sheet embodiment of personal presentation coach 10 in a semi-closed configuration. A flat sheet of any size has been folded along fold lines 15 to create six discreet panels for viewing information. On the front of coach 10 is a unique iconic symbol 12 indicating what individual type should make use of coach 10. In this embodiment, a title for the unique symbol 13 and a textual description of the unique symbol 14 are also displayed on the front panel. Advantageously, the “Do's”, “Don'ts” and “Cheats” sections are displayed on the back panel, so that they may be easily found when this tri-fold embodiment of personal presentation coach 10 is in a folded configuration.

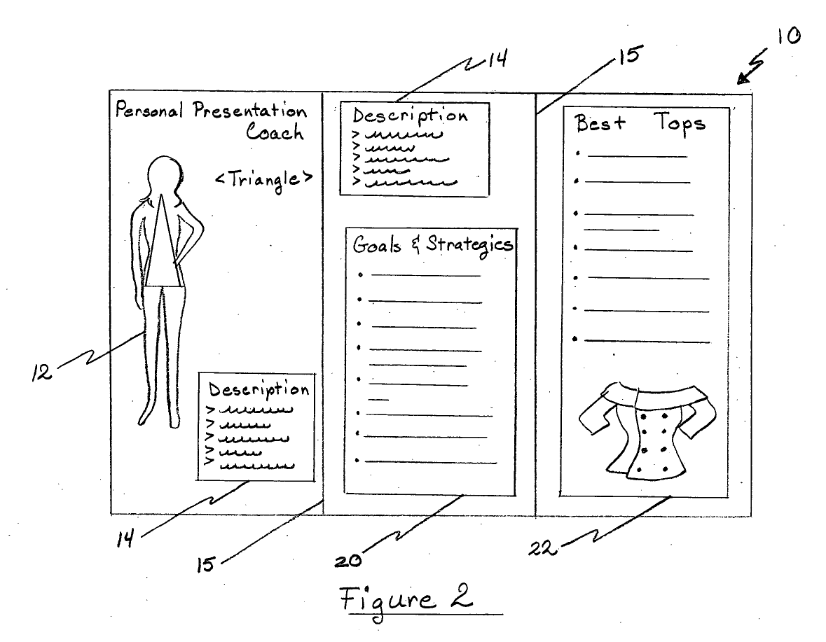

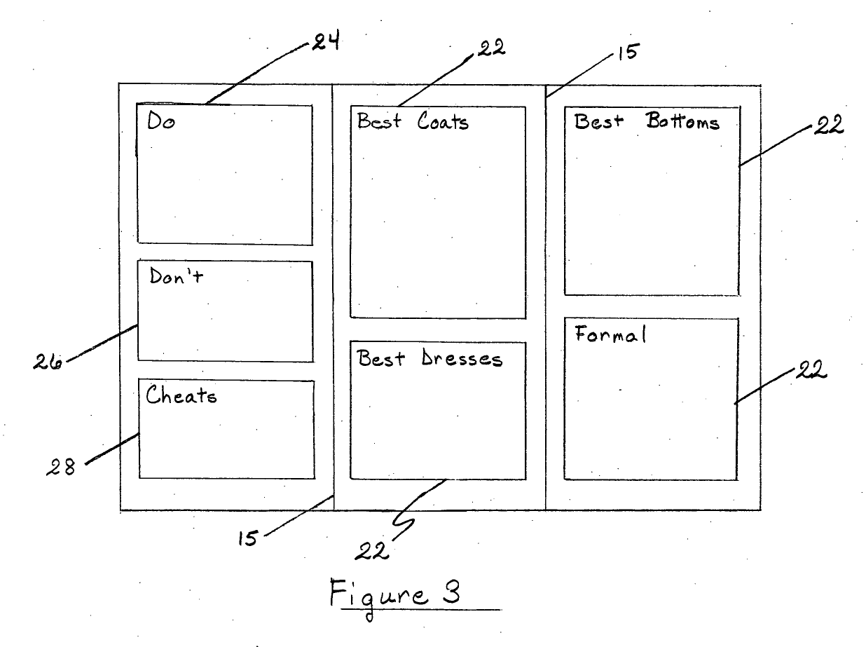

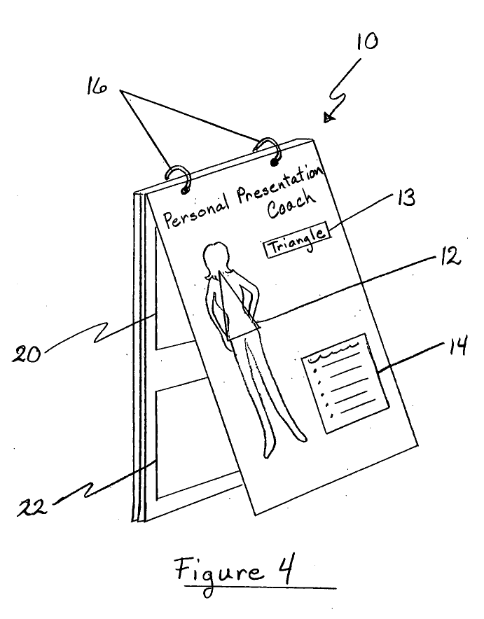

FIG. 2 is an orthogonal front view of a tri-folded flat sheet embodiment of personal presentation coach 10 in an open configuration. Unique iconic symbol 12, symbol title 13 and symbol description 14 are visible in the first panel as they also appeared in FIG. 1. In this open configuration two further panels are visible. In the example illustrated, the center panel contains a repeated display of symbol description 14 and a block 20 displaying “Goals and Strategies” for the individual type. In this embodiment the right hand panel displays a block 22 of recommendations or educational information. Each panel may display one or more blocks 22, as illustrated in FIG. 3.

FIG. 3 is an orthogonal back view of a tri-folded flat sheet embodiment of personal presentation coach 10 in an open configuration. Since this is the back side of the flat sheet “Do's” block 24, “Don'ts” block 26 and “Cheats” block 28 are placed on the left panel, where they will be still viewable when personal presentation coach 10 is in a folded configuration. The central and right panel each contain one or more blocks 22 of recommendations or educational information.

While a tri-fold flat sheet is illustrated, the personal presentation coach is displayable through any configuration of folding or a flat sheet, printed on one side or two.

One advantage of a tri-folded or any multi-folded embodiment of personal presentation coach 10 over a single flat sheet or card is that relevant information may be viewed discreetly by re-folding the coach as one would a map. For example, a shopper holds personal presentation coach 10 folded such that the “Best Dresses” recommendations are held in one hand for easy reference while shopping. When she moves to the pants aisle, she simply re-folds the coach to reveal only block 22 with the “Best Pants” recommendations. It is advantageous that any embodiment of personal presentation coach 10 created by folding a flat sheet of material be laminated for durability. Reenforcement of fold lines 15 may be accomplished by any of many methods well known to those of skill in the art.

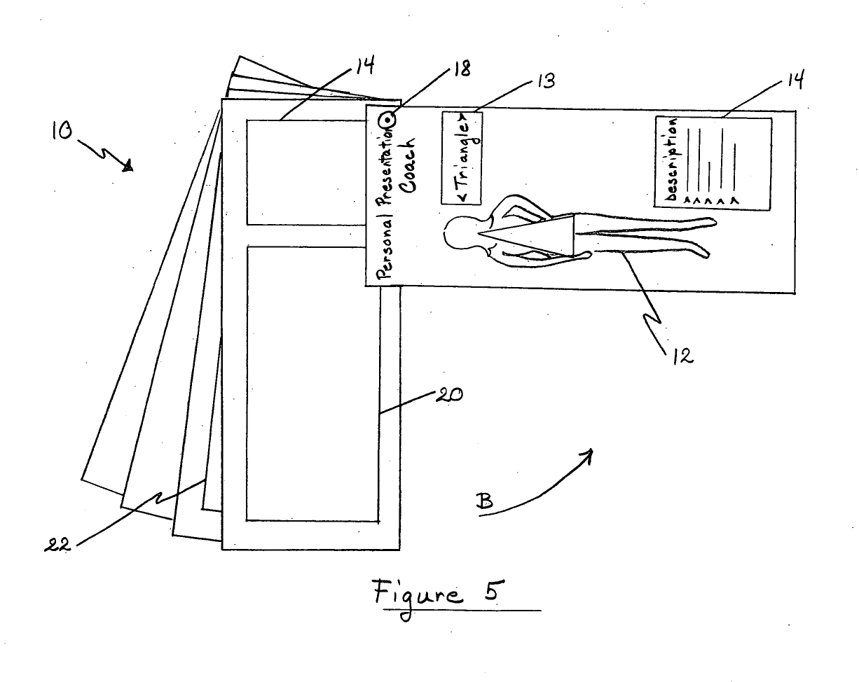

FIG. 4 is a front perspective view of a flip book embodiment of personal presentation coach 10. In this embodiment, flat pages are bound at an upper or side edge using one or more rings 16 or any other binding known in the art, such as a spiral binding or a perfect (glued) binding. When in the purchasable configuration, the front page displays the unique iconic symbol 12, its title 13 and description 14. Advantageously, the back page displays “Do's” block 24, “Don'ts” block 26 and “Cheats” block 28 (not shown in FIG. 4). When in use, the user flips each succeeding page over to reveal the next page's information until the desired block of information is displayed, for example “Goals and Strategies” block 20 and recommendations or educational information blocks 22, as shown in the illustration on the second page. As with most printed material, it is advantageous to use both sides of the pages for display. The back sides of pages can be viewed by turning the apparatus front to back relative the user.

FIG. 5 is a front perspective view of a fan embodiment of personal presentation coach 10. In this embodiment, flat pages are bound at an upper corner using a fan pinning means 18. When the fan is in a closed configuration, the front page advantageously contains the unique iconic symbol 12, its title 13 and description 14. Optionally, the back page displays “Do's” block 24, “Don'ts” block 26 and “Cheats” block 28 (not shown in FIG. 5). When in use, the user rotates each successive page around pin 18 in the direction of arrow B revealing the next page's information until the desired block of information is displayed, for example, “Goals and Strategies” block 20 shown on the second forward facing page or recommendations or educational information blocks 22, as shown in the illustration on the third forward facing page. In this embodiment, information can be displayed on both sides of the pages and can be viewed by turning the apparatus front to back relative the user.

Another fan-like embodiment (not illustrated) incorporates a casing into the design, such that the pages of the fan fold out from the case, similar to a pocket knife with multiple blades. Pages could fold out from one end of the case or two. Any embodiment where pages are folded or stacked together and then “fan” out for viewing is considered a variant of a fan embodiment.

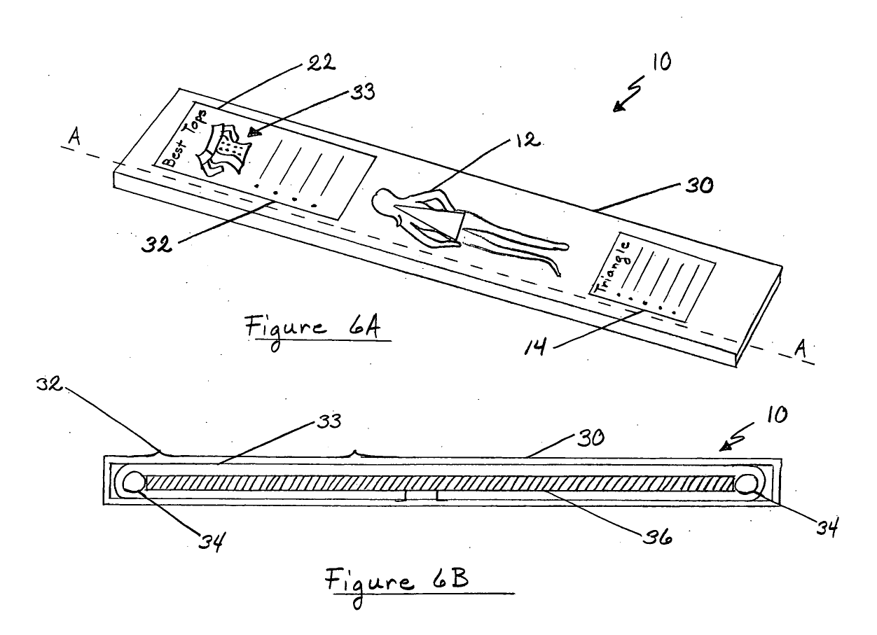

FIG. 6A is a front perspective view of a slider embodiment of personal presentation coach 10. In this embodiment, a rectangular casing 30 contains slider tape 33 which is printed with discreet displayable information. Information is viewable in discreet blocks within a window 32 cut into the casing 30. A recommendation or educational information block 22, printed on slider tape 33 is illustrated as showing through window 32. Any of the discreet information discussed thus far may be printed on tape 33 and viewed through window 32, including “Goals and Strategies” block 20. To change the block of information that is being viewed the user slides tape 33 up or down using the friction of a thumb or finger against the surface of the tape. Alternately, the user winds with a handle attached to tape roller 34 inside the casing, as one would a cartridge of film inside a camera (not shown in FIGS. 6A and 6B). In FIG. 6A, the outside of casing 30 is printed with unique iconic symbol 12, its title 13 and description 14. Advantageously, the bottom of casing 30 is printed with “Do's” block 24, “Don'ts” block 26 and “Cheats” block 28 (not shown in FIG. 6A).

FIG. 6B is also a view of the slider embodiment of personal presentation coach 10 illustrated in FIG. 6A. FIG. 6B is a cutaway side orthogonal view sectioned along line A-A in FIG. 6A. Casing 30 contains slider tape 33 which is wrapped around slider rollers 34. Filler material 36, such as a cardboard insert, holds tape 33 against window 32. When tape 33 is rolled clockwise or counterclockwise around rollers 34, it slides over filler material 36 and around the inside of casing 30. As tape 33 is rotated new blocks of information will show in window 32. Tape 33 may be formed of a continuous band or have some means for stopping its rotation around rollers 34 before the ends of tape 33 appear in window 32.

Any embodiment where a tape containing blocks of personal presentation information slides along a masking structure, revealing the blocks discreetly through an opening is considered a variant of a slider embodiment.

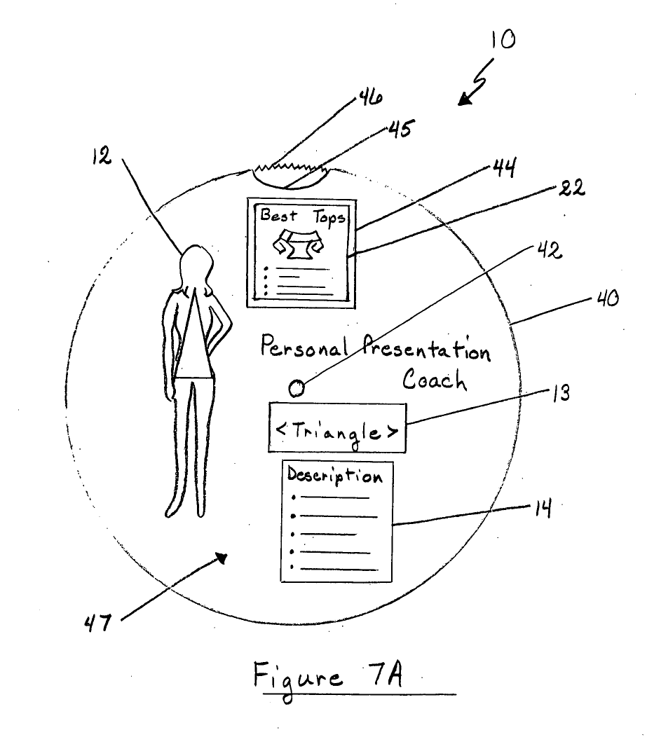

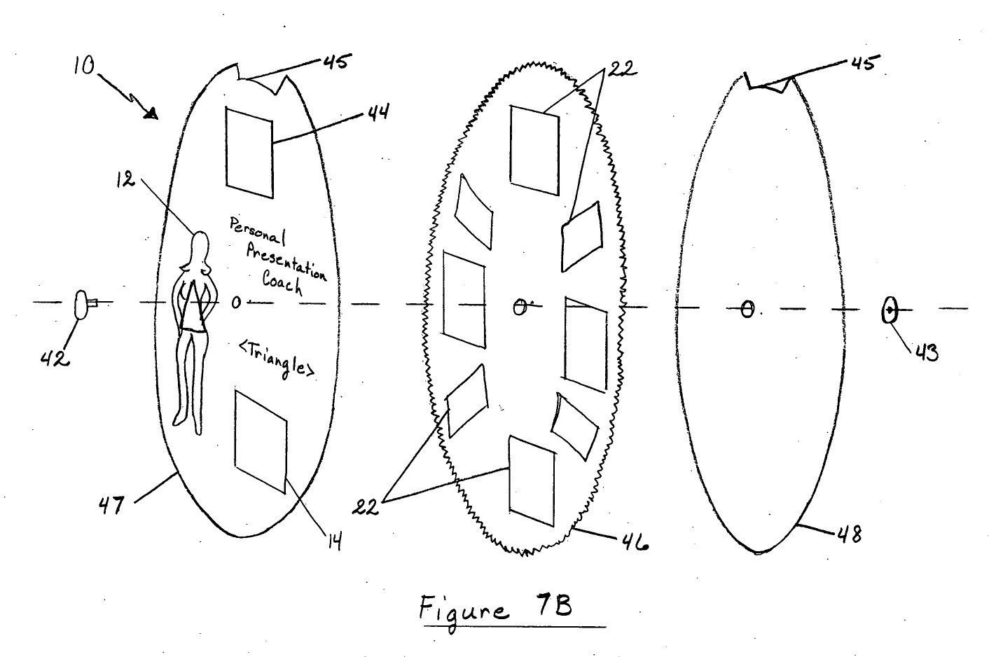

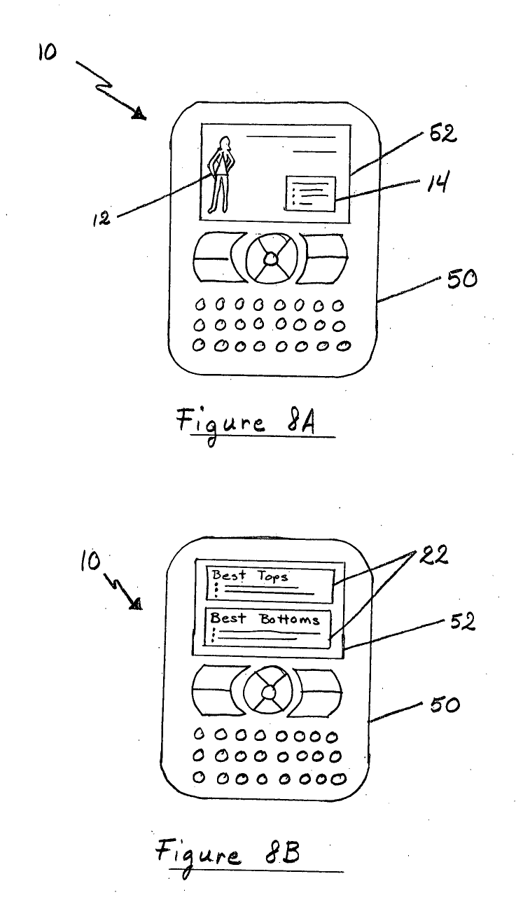

FIG. 7A is an orthogonal front view of a wheel embodiment of the personal presentation coach. In this embodiment, three flat printable layers are held together in their centers by a fastening means. It is advantageous for the layers to be shaped as concentric circles. The two exposed layers form wheel case 40, which sandwiches an inner layer, wheel display layer 46. Wheel case front 47 has cut out of its surface window 44. Through window 44, discreet blocks of information that are printed on wheel display layer 46 are viewable, such as recommendations or educational material block 22. Wheel case 40 (both wheel case front 47 and wheel case back 48) has cut into an edge notch 45. To change the block of information that is being viewed the user rotates display layer 46 around wheel pin 42 while holding wheel case 40 stationary, by using the friction of a finger or thumb against the edge of wheel display layer 46 that is exposed in notch 45. Wheel display layer 46 advantageously has a serrated edge to aid in such a rotation. Multiple blocks of information are printed around the circumference of wheel display layer 46. Any of the discreet information discussed thus far may be printed on wheel display layer 46 and viewed through window 44, including “Goals and Strategies” block 20. In this embodiment, the outside of wheel case 40 is printed with unique iconic symbol 12, its title 13 and description 14. Advantageously, the back side of wheel case 40 (the outer surface of wheel case back 48) is printed with “Do's” block 24, “Don'ts” block 26 and “Cheats” block 28 (not shown in FIG. 7A).

FIG. 7B is an exploded front perspective view of a wheel embodiment of the personal presentation coach. The fastening means illustrated is a pin 42 combined with pin clamp 43. However, it should be understood that any fastening means known in the art may be employed provided that it allows the free rotation of wheel display layer 46 within wheel case 40. FIG. 7B clearly illustrates the disposition of information blocks upon the surface of wheel display layer 46, such that they can be viewed through window 44 upon rotation relative to wheel case front 47.

Other variations of the wheel embodiment are possible, and any embodiment where rotation of a sheet containing blocks of personal presentation information reveals the blocks discreetly through an opening is considered a variant of a wheel embodiment.

FIGS. 8A & 8B are front orthogonal views of a hand held digital device embodiment of personal presentation coach 10. A hand held digital device 50 displays discreet blocks of information, such as recommendations and educational material blocks 22 pictured in FIG. 8B. Such devices include cell phones, personal digital assistants (PDA's) and palm top computers, but any electronic display device 50, which is compact and portable according to the definitions of this disclosure, which embodies a display screen 52, and is either programmable or has access to a distributed network (such as the Internet) is suitable for use as personal presentation coach 10.

The content and display layout of information is in accord with the disclosures of the non-digital embodiments above. Methods for the display of information are accomplished through digitally stored images and text accessed through programed code and software applications well known in the art of digital information display. Unlike the non-digital embodiments above, navigation between discreet blocks of information need not be accomplished through a physical manipulation of the apparatus, such as folding or rotating. In the case of a hand held digital device, navigation is accomplished through menu navigation, webpage address input, virtual keyboard, screen button selection, icon selection, listbox selection, “hotkeys”, “drill down” using images and other user interface programming devices well known in the art that navigate the user from one display “page” to another. Physical interaction with the device is accomplished through touchpad navigation, rocker pad manipulation, keyboard, scroll wheel, thumb wheel and any other user interface means now known or later developed.

In FIG. 8A, unique iconic symbol 12, its title 13 and description 14 are displayed in an opening home page or “splash” screen. One advantage of a digital display is that navigation to a display of any of the discreet information blocks, including “Do's” block 24, “Don'ts” block 26, “Cheats” block 28, “Goals and Strategies” block 20 and recommendations and educational materials blocks 22, may be accomplished from any other display screen.

The program of personal presentation coach 10 is introduced into the hand held digital device 50 through any means well known to those in the art. Some examples of such means currently in usage are: 1) installation as software through a memory card, by connection to another hardware computing device or by broadcast reception; 2) download from a distributed network, such as the Internet; or 3) the program can be run directly from a distributed network server, such as those that run interactive websites over the Internet. A common device for sales of material that is constantly changing, such as fashion and manners, is to provide a subscription service. As part of the subscription, updates to the software are automatically or selectively downloaded at regular intervals, for example, monthly or quarterly. Alternatively, if the program is accessed by using a password to enter a site on a distributed network, such as a website on the Internet, information is maintained by the website administrators and is always current. The user pays a one time or periodically charged fee to access the site, as is done with many Internet subscription service providers, such as the Encyclopedia Britannica, AAA and Consumer Reports.

With the installation of software comes the possibility of purchasing and installing multiple coaches in one purchase package. For example, a woman of “triangular” shape could purchase personal presentation coaches for how to dress in 50 cultures. The coach still targets a specific individual type for a specific presentation component, but with digital portability it is now possible to carry 50 coaches in a hand held digital device on her person while traveling the world. Alternatively, the personal presentation coach could cover Fall, Winter, Summer and Spring seasonal dressing in cold, temperate and tropical climes. This would be the combination of 12 coaches in one package, the distinguishing element being that the coaches are still targeted to a specific individual type and only that type. Once the user has selected, through digital navigation described above, Fall in a temperate climate the recommendations for clothing purchase present only the “Goals and Strategies”, “Do's”, “Don'ts”, “Cheats” and other information for a “triangular” woman in a temperate climate in the Fall.

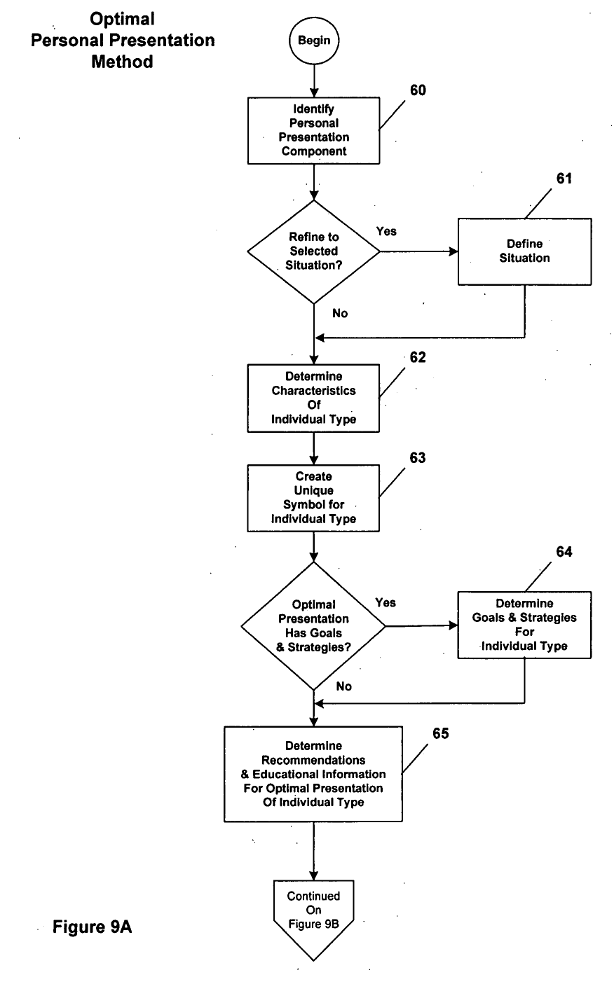

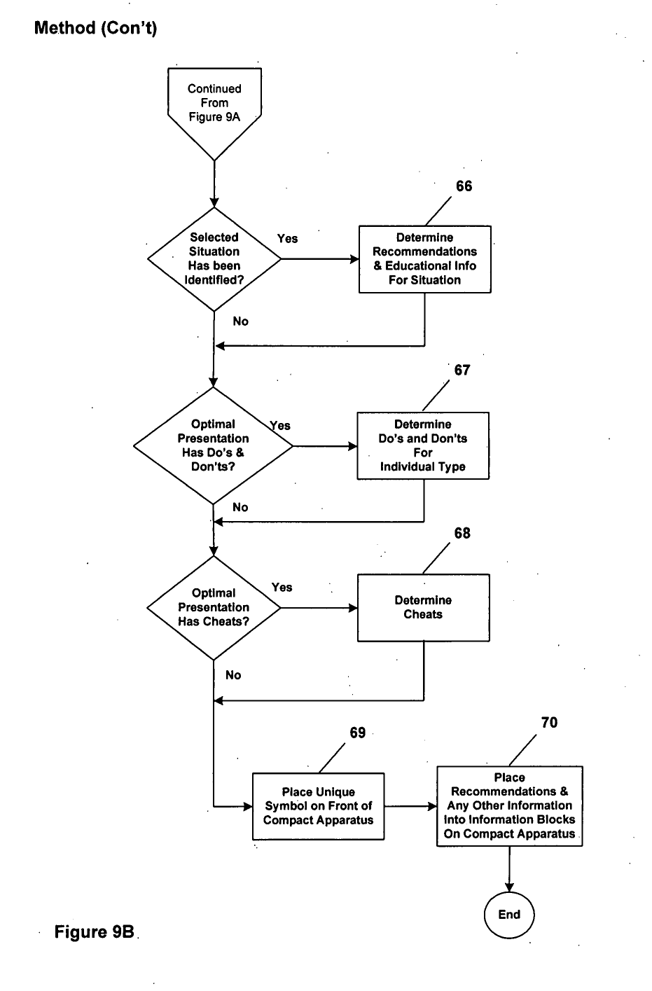

FIG. 9 is flowchart of steps for a method of creating an optimal personal presentation. The first step, step 60, is to identify the presentation component to be addressed by the coach. For example, a coach will be focused on women's makeup or, as another example, business etiquette.

For step 61, it must be decided whether the coach will be further refined to a selected situation, for example, make-up for evening or day, or business practices in Japan. If a further refinement seems desirable, the specific situation is defined. Sometimes a developer reaches the end of the personal presentation creation process and finds that the recommendations and educational material necessary for a presentation component for the individual type are too numerous for reasonable display in a compact, personal presentation coach. In this case, the developer may return to step 61 and iterate the process reducing the recommendations and educational material by targeting it to a specific situation.

During step 62, a type of individual who will be using the coach for developing an optimum presentation is determined. It is then determined what characteristics are unique to the individual type. Once the characteristics have been determined, a unique iconic symbol for the individual type is created in step 63. It is advantageous that the entire set of individual types for a selected presentation component are developed together and, optionally, that the unique symbols created interrelate. For example, determining the body characteristics of one type of woman buying clothing will inform the determination of other types. One has a narrow waist, another a thicker waist. The designer decides on a schematic outline of an hour glass and an oval for the respective symbol components. This will inform how a tall, thin woman's waist is characterized, with a thin, tall rectangle component, for example. If the developer has all the characteristics established that she wishes to address in the coaches for this presentation component set, then developing interrelated iconic symbols in step 63 is easier, as in the case of using geometric shapes for the body types. The unique iconic symbol must communicate the type of individual to use the coach and, optionally, it also communicates the personal presentation component or components being addressed and the selected situation or situations the coach is used for, if any are specified.

A decision is made whether step 64 will be necessary. If the optimal presentation sought lends itself to specifying general goals and strategies for achieving the optimal presentation, the goals and strategies are determined in step 64.

In step 65, recommendations and educational information for creating the optimal presentation are developed. The next decision is whether a specific situation has been selected for this presentation. If a specific situation has been selected, this influences the development of the recommendations and educational information, and this is done in step 66. For example, if the recommendations are for the presentation component of clothing, the individual type is a triangularly shaped woman, and a situation has been elected that the presentation is being made in a northern climate in Winter, recommendations are developed for the appropriate coats, scarves and hats, and, perhaps, recommendations for swimsuits are omitted.

At this point in the process it is determined whether the optimal presentation has “Do's” and “Don'ts” as defined above. “Do's” and “Don'ts” are determined and refined in step 67.

The same is true for “Cheats” which may be possible for the optimal presentation. “Cheats” determined and refined in step 68 may be work-arounds for the “Do's” and “Don'ts” created in step 67 or they may be work-arounds for other recommendations and educational information created in steps 65 and 66.

In steps 69 and 70, the aspects of creation of an optimal presentation are placed into a compact apparatus for use by the individual. The apparatus has a place where the unique symbol developed may be easily viewed, that place is determined and the symbol positioned in step 69. A unique symbol title and description may also be placed for initial and easy viewing. Then, all of the above developed aspects of the creation of an optimal personal presentation, goals and strategies, recommendations and educational information, “Do's” and “Don'ts” and “Cheats”, are divided into information blocks and placed within or upon the apparatus for display. For example, recommendations for various clothing choices are divided into blocks for “Best Jackets and Coats”, “Best Tops” and “Best Bottoms”. Depending on the display apparatus, “Best Bottoms” may be divided into blocks for “Best Skirts”, “Best Pants” and “Best Shorts”. How many information blocks are developed and how they are placed depends upon the apparatus as well as the total amount of information it is advantageous to communicate. Once designed, the apparatus is manufactured, marketed and distributed, some methods of which are described elsewhere in this disclosure.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

### INDUSTRIAL APPLICABILITY

The method and apparatus disclosed have far reaching applicability in numerous merchant and service industries, as well as filling a pressing need in the industries involved for a means to educate consumers and inspire confidence in the purchasing public.

In order to further understand the method and apparatus disclosed, consider a consumer concerned with making the best possible presentation of herself in American society. The problem immediately at hand is the purchase of some flattering clothing. While she owns some clothes that she believes flatter her, this consumer has never been able to pair down the overwhelming number of fashion recommendations available in the media to a list of clothing purchase recommendations that are best for her body type.

As she enters the mall, she sees a rack displaying laminated booklets. On the front face of each booklet is a female figure with a geometric symbol. Picking up a booklet with an oval on the figure she reads, “Oval” and “Description: Smaller bust and rib cage, Wide waist, Narrow hips . . . ” The consumer doesn't need to read further; she knows that is not her body type. So, she quickly scans the booklet fronts and finds the one with a figure of a woman and a triangle, the widest part at the hips. On this she reads, “Triangle” and “Description: Smaller bust and rib cage, Narrow waist, Wider hips, Generous thighs . . . ” Recognizing this as a good description of her body type, she purchases the booklet.

Once opened, the booklet fans out to reveal 5 or 6 pages of concise, bulleted lists. In less than 2 minutes she is able to scan the general “Goals and Strategies” for buying clothing for her body type, “Focus attention on upper body, Enlarge shoulders to balance wider hips, Enhance midriff, Downplay lower body.” Each goal also has a 3 or 4 more specific recommendations explaining how one would accomplish these goals and strategies. For example, under “Enlarge shoulders . . . ” is listed, “Boatneck collars, Shoulder pads.” Walking into her favorite store, she goes to the blouse rack. Turning to a page titled, “Best tops”, she scans the information. “Take advantage of shoulder pads, Tailored or semi-fitted tops to accentuate small waist, Brighter colors to lead the eye upwards . . . ” Quickly, browsing the rack she selects several blouses in her size that comply with these recommendations. At the pants rack, she fans the booklet to the “Best bottoms” page. Here she reads, “Fluid, drapey fabrics are essential for pants and skirts as they should skim, not hug the body,” and, “Dark, muted colors are best on bottom to keep the lower body downplayed. Avoid brighter colors below.” Again, best choices are much clearer in her mind with the coach right in her hand.

At this point, the consumer is probably wondering if there is a presentation coach available for best hairstyles for her facial shape and hair weight, or for best makeup for her hair, eye and skin coloring.

As seen above, one excellent location to offer the personal presentation coach for clothing presentation would be in a beautiful rack display at the entrance lobbies of a major department store. Other good locations for display of the coaches is at the entrances to hair salons and barber shops for hair and make-up presentation, and the entrances to office and computer supply stores, downtown office buildings and airport newspaper shops for the business etiquette presentation. Major department store management has long understood that an informed consumer is a confident consumer and a confident consumer is much more likely to buy. Major department stores have employed a similar sales method when they encourage customers to “have their colors done” by “color consultants” at little or no cost. They understand that these customers then purchase makeup, clothing, jewelry and accessories to correspond with their newly determined colors. Hiring a consultant, however, is not as long lasting and convenient as having an apparatus in your pocket that can act as your consultant in any situation, now or in future.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. A personal presentation coach adapted for creating a personal presentation for a selected type of individual, comprising:
a compact information display structure; and
an iconic symbol uniquely associated with the selected type of individual;
the compact information display structure further comprising a block of information adapted for creating personal presentation only for the selected type of individual, the information selected from the group of informations consisting of: recommended actions adapted for creating the personal presentation, and educational material specific to a personal presentation component.

2. The coach of claim 1 wherein the compact information display structure comprises display in at least one display form selected from the group of forms consisting of graphics, text, photographs, symbols and icons.

3. The coach of claim 1 wherein the compact information display structure is selected from the group of structures consisting of a single flat sheet, a tri-folded or multi-folded sheet, a fan, a flip book, a slider, a multi-layered wheel and digitally-created displays in a compact digital display device.

4. The coach of claim 1 further comprising a block containing a textual description identifying the selected type of individual.

5. The coach of claim 1 further comprising a block containing goals and strategies for creating personal presentation only for the selected type of individual.

6. The coach of claim 1 further comprising a block containing actions for the selected type of individual to do and actions for the selected type of individual not to do.

7. A personal presentation coach adapted for creating a personal presentation for a selected type of individual, comprising:
a compact information display structure;
an iconic symbol uniquely associated with the selected type of individual; and
a block containing goals and strategies for creating personal presentation only for the selected type of individual.

8. The coach of claim 7 wherein the compact information display structure comprises display in at least one display form selected from the group of forms consisting of graphics, text, photographs, symbols and icons.

9. The coach of claim 7 wherein the compact information display structure is selected from the group of structures consisting of a single flat sheet, a tri-folded or multi-folded sheet, a fan, a flip book, a slider, a multi-layered wheel and digitally-created displays in a compact digital display device.

10. The coach of claim 7 further comprising a block containing a textual description identifying the selected type of individual.

11. The coach of claim 7 further comprising the compact information display structure further comprising a block of information adapted for creating personal presentation only for the selected type of individual, the information selected from the group of informations consisting of: recommended actions adapted for creating the personal presentation, and educational material specific to a personal presentation component.

12. The coach of claim 7 further comprising a block containing actions for the selected type of individual to do and actions for the selected type of individual not to do.

13. A method for coaching a selected type of individual in creating an optimal personal presentation, the method comprising the following steps:
a. identifying distinguishing characteristics of the selected type of individual;
b. selecting a characteristic of the type of individual and associating it to a unique iconic symbol;
c. associating the iconic symbol to information selected from the group of informations consisting of: recommended actions adapted for creating the personal presentation, and educational material specific to a personal presentation component; and
d. displaying the iconic symbol and the iconic symbol's associated information on a compact information display structure adapted to be carried by the selected type of individual.

14. The method of claim 13 where the compact information display structure in step 13.dis selected from the group of structures consisting of a single flat sheet, a tri-folded or multi-folded sheet, a fan, a flip book, a slider, a multi-layered wheel and digitally-created displays in a compact digital display device.

15. The method of claim 13 further comprising the following steps:
a. after step 13.a and before step 13.c, creating a textual description of at least one distinguishing characteristic of the selected type of individual; and
b. within step 13.d, displaying the textual description of the at least one distinguishing characteristic of the selected type of individual on the compact information display structure.

16. The method of claim 13 where:
a. after step 13.c and before step 13.d, the unique iconic symbol is further related to goals and strategies for creating personal presentation only for the type of individual; and
b. in step 13.d, the goals and strategies are also displayed on the compact information display structure.

17. The method of claim 13 where:
a. after step 13.c and before step 13.d, the unique iconic symbol is further related to actions for the selected type of individual to do and actions for the selected type of individual not to do; and
b. in step 13.d, the actions to do and actions not to do are also displayed on the compact information display structure.

18. A personal presentation coach adapted for creating a personal presentation for a selected type of individual, comprising:
a compact information display structure, the compact information display structure selected from the group of structures consisting of a single flat sheet, a tri-folded or multi-folded sheet, a fan, a flip book, a slider, a multi-layered wheel and digitally-created displays in a compact digital display device; and
an iconic symbol uniquely associated with the selected type of individual;
the compact information display structure further comprising a block of information adapted for creating personal presentation only for the selected type of individual, the information selected from the group of informations consisting of: recommended actions adapted for creating the personal presentation, and educational material specific to a personal presentation component.

19. A personal presentation coach adapted for creating a personal presentation for a selected type of individual, comprising:
a compact information display structure, the compact information display structure selected from the group of structures consisting of a single flat sheet, a tri-folded or multi-folded sheet, a fan, a flip book, a slider, a multi-layered wheel and digitally-created displays in a compact digital display device;
an iconic symbol uniquely associated with the selected type of individual;
the compact information display structure further comprising a block of information adapted for creating personal presentation only for the selected type of individual, the information selected from the group of informations consisting of: recommended actions adapted for creating the personal presentation, and educational material specific to a personal presentation component;
a block containing goals and strategies for creating personal presentation only for the selected type of individual;
a block containing a textual description identifying the selected type of individual; and
a block containing actions for the selected type of individual to do and actions for the selected type of individual not to do.
